(19) United States
(12) Patent Application Publication
(10) Pub. No.: US 2013/0327632 A1
(43) Pub. Date: Dec. 12, 2013

(54) PHOTOCHEMICAL REACTION DEVICE AND ISOTOPE ENRICHMENT METHOD USING THE DEVICE

(71) Applicants: Shigeru Hayashida, Tokyo (JP); Takashi Kambe, Tokyo (JP); Tetsuya Satou, Tokyo (JP); Takehiro Igarashi, Tokyo (JP); Hiroaki Kuze, Chiba-shi (JP)

(72) Inventors: Shigeru Hayashida, Tokyo (JP); Takashi Kambe, Tokyo (JP); Tetsuya Satou, Tokyo (JP); Takehiro Igarashi, Tokyo (JP); Hiroaki Kuze, Chiba-shi (JP)

(73) Assignee: Taiyo Nippon Sanso Corporation, Tokyo (JP)

(21) Appl. No.: 14/000,689

(22) PCT Filed: Jan. 23, 2012
(86) PCT No.: PCT/JP2012/051319

§ 371 Date: Aug. 21, 2013

(30) Foreign Application Priority Data
Feb. 23, 2011 (JP) 2011-037045

(51) Int. Cl. B01J 19/12

(52) U.S. Cl. CPC B01J 19/121
USPC 204/157.22; 422/186.03

(57) ABSTRACT

The present invention includes: a light-transmissive reaction cell (21) into which a process gas is supplied and the process gas is photochemically reacted by laser light; a metal mirror (19) which is set up outside of the light-transmissive reaction cell (21) so as to encompass the light-transmissive reaction cell (21), and which reflects laser light; and a cryostat (11) which is configured to accommodate the light-transmissive reaction cell (21), the metal mirror (19), and a cryogenic liquid (12), and which maintains a temperature of the metal mirror (19) at a cryogenic temperature by the cryogenic liquid (12).

### TECHNICAL FIELD

The present invention relates to a photochemical reaction device using laser light, and an isotope enrichment method using the photochemical reaction device.

Priority is claimed on Japanese Patent Application No. 2011-037045, filed Feb. 23, 2011, the content of which is incorporated herein by reference.

### BACKGROUND ART

There are two main types of photochemical reaction device using laser light. One involves a one-pass system in which laser light transits a photochemical reaction container called a photochemical reaction cell only once, while the other involves a multi-reflection system in which laser light is reflected multiple times.

A multi-reflection system is optically complex with respect to the positioning of installed reflecting mirrors and the like, and is a system that requires precision, but it enables efficient use of laser light in photochemical reaction. There are commercial multi-reflection cells for gas analysis (brand names include, for example, White Cell, White is a person's name) that have an optical path length of 200-300 m, and light is reflected 200-300 times in such cells.

Photoabsorption in cases where a multi-reflection system is used is represented by the Lambert-Beer Law as shown in the following formula (1).

I(z)=I₀e^{-σNz} (1)

In the above formula (1), I₀ indicates an initial light quantity [W], I(z) indicates a light quantity [W] in an optical path length z [cm], σ indicates a cross-sectional area of photoabsorption [cm²/molecule], and N indicates molecular density [molecules/cm³]. In the foregoing formula (1), photoabsorption increases as the optical path length z increases.

A light usage rate η is represented by the following formula (2) (provided that σNz<<1), and increases in proportion to the optical path length z.

$$η ≡ \frac{{I}_{0} - I ( z )}{{I}_{0}} = 1 - {e}^{- σ Nz} ≅ σ Nz \qquad ( 2 )$$

Patent Documents 1 and 2 disclose a method for enriching ¹⁷O and ¹⁸O, which are oxygen isotopes, by irradiating ozone molecules containing ¹⁷O and ¹⁸O with laser light to selectively decompose these ozone molecules.

When this method is used, the photoabsorption cross-sectional area σ at a wavelength where absorption is relatively large in the Wulf band (the near-infrared region of 700-1200 nm) of ozone is a low value of 10⁻²³ cm²/molecule (approximately 4 orders smaller than the photoabsorption cross-sectional area of water). Consequently, the optical path length of a photochemical reaction cell is preferably 1000 m or more.

Therefore, in cases where a photochemical reaction is conducted with the foregoing small photoabsorption cross-sectional area, it is advantageous for the photochemical reaction cell to employ a multi-reflection system cell.

### PRIOR ART

### Patent Documents

Patent Document 1: Japanese Patent No. 4364529

Patent Document 2: Japanese Unexamined Patent Application, First Publication No. 2006-272090

Patent Document 3: Japanese Unexamined Patent Application, First Publication No. H7-265669

Patent Document 4: Japanese Unexamined Patent Application, First Publication No. H7-150270

Patent Document 5: Japanese Unexamined Patent Application, First Publication No. H3-329885

### DISCLOSURE OF INVENTION

### Problem to be solved by the Invention

Incidentally, considering a photochemical reaction cell of a multi-reflection system, when mirror reflectance is about 0.90, and when reflection is conducted 10 times (with 5 reciprocations), final light intensity is 0.90¹⁰=0.35, and optical loss of the mirror is 65%. Based on this, there is the problem that optical usage efficiency cannot be raised very high in the case where a cell of the aforementioned reflectance is used.

For example, the reflectance of a gold mirror at a wavelength of 1000 nm is 0.98 at room temperature (e.g., 20° C.). Consequently, a high reflection frequency cannot be adopted at room temperature (final light intensity at a reflection frequency of 50 is 0.98⁵⁰=0.36).

In order to have little light loss even in cases where reflection frequency is 1000 times or more, it would be necessary to have a reflectance of 0.999 or more (final light intensity in this case would be 0.999¹⁰⁰⁰=0.37). For example, in the case where reflection frequency is 10,000 times at a reflectance of 0.9999, final light intensity would be 0.9999¹⁰⁰⁰⁰=0.37, and total optical path length would be 10,000 m or more when average optical path length until 1 reflection is set to 1 m.

Dielectric multilayer film has a high reflectance of 0.9999 or more, but there is the problem that reflectance declines when the angle of incidence is large. Consequently, to apply a dielectric multilayer film to a photochemical reaction device of a multi-reflection system, difficult issues exist such as the laser incidence method and optical axis adjustment.

For example, a dielectric multilayer film used in cavity-ring-down spectroscopy has a high reflectance of 0.9999 or more. However, in the case where a system is adopted in which light is received after first being transmitted by dielectric multilayer film, transmittance is several % or less, resulting in a large transmission loss. Consequently, although dielectric multilayer film can be used in spectroscopy, it is not suited to photochemical reaction.

Thus, with conventional technology, the types of high-reflectance mirrors are limited, and the methods for lengthening total optical path length—i.e., the methods for raising the usage efficiency of laser light in photochemical reaction—are limited.

The object of the present invention is to provide a photochemical reaction device that enables enhancement of usage efficiency of laser light in photochemical reaction, and an isotope enrichment method using this photochemical reaction device.

### Means for Solving the Problems

A first aspect of the present invention provides the following photochemical reaction device.

(1) A photochemical reaction device, including: a light-transmissive reaction cell in which a process gas is supplied and a photochemical reaction is carried out with a laser light; a metal mirror which is set outside of the aforementioned light-transmissive reaction cell so as to encompass the light-transmissive reaction cell, and which reflects the aforementioned laser light; and a cryostat which accommodates the aforementioned light-transmissive reaction cell, the aforementioned metal mirror, and a cryogenic liquid, and which maintains the temperature of the aforementioned metal mirror at a cryogenic temperature by the aforementioned cryogenic liquid.

It is preferable that the photochemical reaction device of (1) have the features shown below.

(2) The photochemical reaction device of (1) above, wherein the temperature of the aforementioned metal mirror is 100 K or less.

(3) The photochemical reaction device shown in (1) and (2) above, wherein a vacuum insulation space exists between the aforementioned light-transmissive reaction cell and the aforementioned metal mirror.

(4) The photochemical reaction device shown in (1) to (3) above, wherein the aforementioned metal mirror is made of any one metal of gold, silver, copper, and aluminum.

(5) The photochemical reaction device of (4) above, wherein the purity of the aforementioned metal is 99.9999 or more.

(6) The photochemical reaction device shown in (1) to (5) above, wherein the aforementioned metal mirror is a metal film.

(7) The photochemical reaction device shown in (1) to (6) above, wherein the aforementioned light-transmissive reaction cell is made of quartz glass or acrylic resin.

(8) The photochemical reaction device shown in (1) to (7) above includes a laser light waveguide through which the aforementioned process gas is irradiated with the aforementioned laser light.

(9) The photochemical reaction device shown in (1) to (8) above includes a metal cell which is composed of the same metal as the metal mirror, and that has a purity lower than that of the aforementioned metal mirror, which is accommodated in the aforementioned cryostat, and which accommodates the aforementioned light-transmissive reaction cell; and the aforementioned metal mirror is set up so as to cover the inner surface of the aforementioned metal cell.

(10) The photochemical reaction device shown in (1) to (8) above has a quart glass cell which is accommodated in the aforementioned cryostat, which accommodates the aforementioned light-transmissive reaction cell, and which transmits the aforementioned laser light; and the aforementioned metal mirror is set up so as to cover the inner surface of the aforementioned quart glass cell or the outer surface of the aforementioned quart glass cell.

(11) The photochemical reaction device of (10) above, wherein the aforementioned quart glass cell is made of high-purity quartz glass with a purity of 99% or more, and a light transmission loss of 0.1 dB/m or less.

(12) The photochemical reaction device shown in (8) and (9) above, wherein the aforementioned laser light waveguide is set up in the aforementioned light-transmissive reaction cell.

(13) The photochemical reaction device shown in (8) to (11) above, wherein the aforementioned laser light waveguide is set up within the vacuum insulation space.

(14) The photochemical reaction device shown in (8) to (13) above, wherein the aforementioned laser light waveguide is optical fiber(s).

(15) The photochemical reaction device shown in (1) to (14) above, wherein a line heater is wound on the outer wall of the aforementioned light-transmissive reaction cell.

(16) The photochemical reaction device of (9) above, wherein a quart glass cell which transmits the aforementioned laser light and encompasses the aforementioned light-transmissive reaction cell is provided between the aforementioned light-transmissive reaction cell and the aforementioned metal mirror, and a vacuum insulation space is set up between the aforementioned light-transmissive reaction cell and the aforementioned quart glass cell.

(17) The photochemical reaction device of (16) above, wherein the aforementioned laser light waveguide is set up outside of the aforementioned quart glass cell.

(18) The photochemical reaction device shown in (16) and (17) above, wherein the aforementioned quart glass cell is made of high-purity quartz glass with a purity of 99% or more, and a light transmission loss of 0.1 dB/m or less.

(19) The photochemical reaction device shown in (1) to (18) above, wherein the aforementioned light-transmissive reaction cell is made of high-purity quartz glass with a purity of 99% or more, and a light transmission loss of 0.1 dB/m or less.

(20) The photochemical reaction device shown in (1) to (19) above, wherein the aforementioned cryostat has a first cell that accommodates the aforementioned cryogenic liquid, a second cell that accommodates the aforementioned first cell, and a vacuum insulation space provided between the aforementioned first cell and the aforementioned second cell.

(21) The photochemical reaction device of (20) above includes a reliquefaction device that is connected to the aforementioned first cell, and that reliquefies a boil-off gas from the aforementioned cryogenic liquid.

(22) The photochemical reaction device shown in (1) to (21) above, wherein the aforementioned cryogenic liquid is liquid helium.

A second aspect of the present invention provides the following isotope enrichment method.

(23) An isotope enrichment method using the photochemical reaction device according to any one of (1) to (22) above, including: a step in which a mixture of O₃ and CF₄ as a process gas is supplied into the aforementioned light-transmissive reaction cell; and a succesive step in which the aforementioned O₃ containing the oxygen isotope ¹⁷O or ¹⁸O is selectively photodecomposed by photochemical reaction by irradiating the aforementioned mixture with the aforementioned laser light.

It is preferable that the isotope enrichment method of (23) above have the features shown below.

(24) The isotope enrichment method of (23) above, wherein the wavelength range of the aforementioned laser light during the aforementioned photodecomposition is 500 nm or more.

(25) The isotope enrichment method of (23) above, wherein the wavelength range of the aforementioned laser light during the aforementioned photodecomposition is 700-1500 nm.

### Effects of the Invention

According to the photochemical reaction device and the isotope enrichment method using the photochemical reaction device of the present invention, it is possible to raise the laser light reflectance of a metal mirror by conducting cooling with a cryogenic liquid so that the metal mirror reaches cryogenic temperature. By this means, laser light usage efficiency in photochemical reaction can be raised.

### BRIEF DESCRIPTION OF THE DRAWINGS

FIG. 1 is a drawing which shows the relation between wavelength and reflectance of gold, silver, and copper at room temperature (e.g., 20° C.).

FIG. 2 is a drawing which shows the specific resistance of copper and aluminum at a cryogenic temperature.

FIG. 3 is a cross-sectional view which shows a schematic configuration of a photochemical reaction device of a first embodiment of the present invention.

FIG. 4 is a cross-sectional view which shows a schematic configuration of a photochemical reaction device of a second embodiment of the present invention.

FIG. 5 is a cross-sectional view which shows a schematic configuration of a photochemical reaction device of a third embodiment of the present invention.

FIG. 6 is a cross-sectional view which shows a schematic configuration of a photochemical reaction device of a variation of the third embodiment of the present invention.

FIG. 7 is a cross-sectional view which shows a schematic configuration of a photochemical reaction device of a fourth embodiment of the present invention.

### BEST MODE FOR CARRYING OUT THE INVENTION

The reflectance of metal in infrared and near-infrared regions (a wavelength of approximately 800 nm or more) is obtained by the Hagen-Rubens formula shown in the following Formula (3).

$$R = 1 - \sqrt{\frac{16 {πɛ}_{0} c ρ}{λ}} \qquad ( 3 )$$

In the foregoing Formula (3), R indicates reflectance, ε₀ indicates the dielectric constant of a vacuum [F/m], c indicates light speed [m/s], λ indicates optical wavelength [m], and ρ indicates electrical specific resistance [Ωm].

Incidentally, with respect to laser light of a fixed wavelength λ, the foregoing Formula (3) can be expressed by the following Formula (4).

R=1−const \sqrt{ρ} (4)

Now, in the foregoing Formula (4), the second term on the right side pertains to eddy current loss, and reflectance increases as specific resistance decreases. Light consists of electromagnetic waves, eddy current is generated such that the magnetic field variation of light is negated on a metal surface, and energy loss occurs due to electric resistance(=specific resistance×length/cross-sectional area). With a perfect conductor (not a superconductor; an imaginary substance), there is perfect reflection (R=1) when eddy current loss is zero.
For example, high-purity copper has a specific resistance of ρ≈10⁻⁸ Ωm at room temperature (e.g., 20° C.), and when the wavelength λ is 1000 nm, the second term on the right side of the aforementioned Formula (3) is 0.0364. Consequently, reflectance R is a value shown by the following Formula (5).

R=1−0.0364=0.9636 (5)

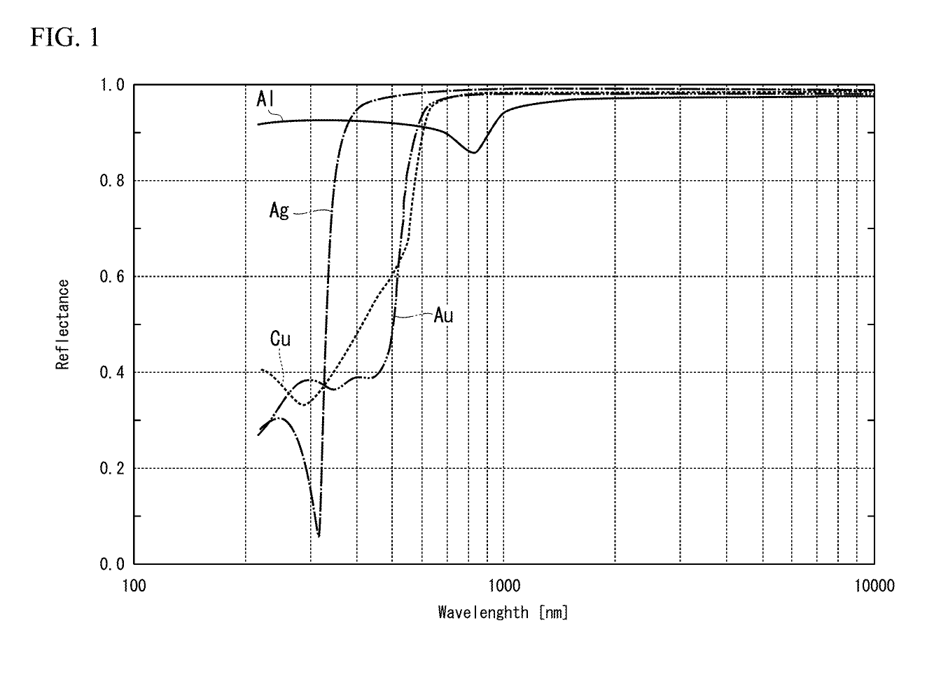

FIG. 1 is a drawing which shows the relation of wavelength and reflectance of gold, silver, and copper at room temperature (e.g., 20° C.). FIG. 1 cites data recorded in Chronological Science Tables (the Rika Nenpyō; a databook edited by the National Astronomical Observatory of Japan).

Referencing FIG. 1, in a wavelength range of 800 nm or more, reflectance is in the order of silver>copper>gold, and specific resistance is in the order of silver<copper<gold, thereby establishing the aforementioned Formula (4).

Specific resistance ρ is expressed by the following Formula (6), and decreases as temperature T [K] declines in accordance with Mathiessen's rule. Moreover, at the temperature (4.2 K) of liquid helium which is a cryogenic liquid, specific resistance p is a constant value referred to as residual resistance ρᵣ [Ωm]. ρᵣ is a value deriving from impurities, lattice defects and the like in metal, and is a value that decreases at cryogenic temperature as purity increases.

The cryogenic liquid referred to herein signifies liquid gas with a standard boiling point of 100 K or less such as liquid nitrogen, liquid oxygen, liquid argon, liquid hydrogen, liquid helium, and so on. The temperature range in which such liquids are used is referred to as cryogenic temperature.

ρ(T)=ρᵣ−ρₚₕ(T) (6)

In the foregoing Formula (6), ρₚₕ(T) is a term based on phonon scattering, and indicates that there is temperature dependency.

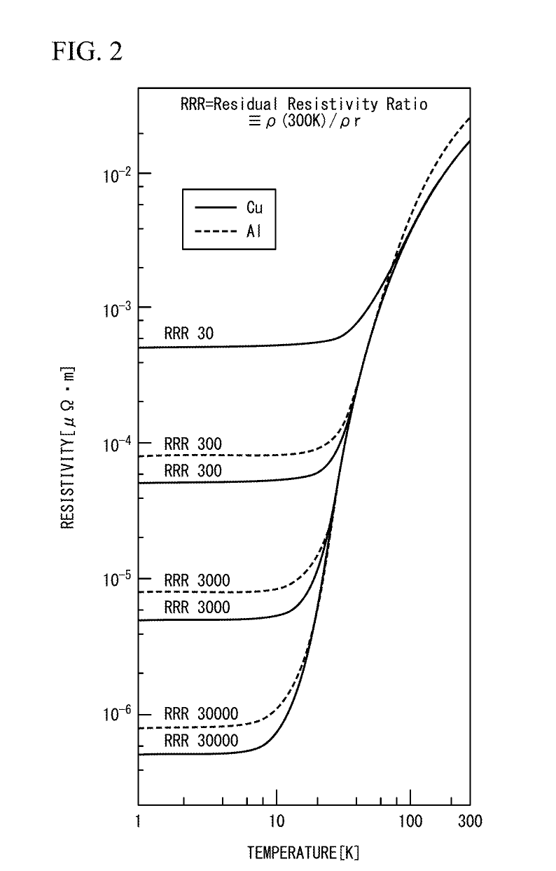

FIG. 2 is a drawing which respectively shows the specific resistance of copper and aluminum at cryogenic temperature. FIG. 2 is cited from the Superconducting and Cryogenic Engineering Handbook (Cryogenic Association of Japan, published by Ohmsha, Ltd.) (original source: Handbook on Materials for Superconducting Machinery, 1977), see page 1084.

The RRR (residual resistivity ratio) shown in FIG. 2 is expressed by the following Formula (7).

$$RRR = \frac{ρ ( 300 K )}{{ρ}_{r}} \qquad ( 7 )$$

As shown in FIG. 2, it is reported that RRR=30000, and when this value is substituted into the aforementioned Formula (4) and the aforementioned Formula (5), the second term on the right side of the aforementioned Formula (3) is 0.0364√ (1/30000)=0.00021. Therefore, as shown in the following Formula (8), reflectance R is 0.99979.

R−1−0.00021=0.99979 (8)

Thus, reflectance R can be raised to 0.99979 (a value close to 0.9999) by cooling the temperature of a metal mirror composed of copper with a reflectance R of 0.96 at room temperature (e.g., 20° C.) to cryogenic temperature. Moreover, this reflectance R has the excellent feature that it is not dependent on the angle of incidence of light.

Furthermore, with respect also to metal mirrors composed of any one material among gold, silver, and aluminum, it is possible to raise reflectance R to 0.99-0.999 or higher by bringing a metal mirror with a reflectance R of 0.9-0.99 at room temperature (e.g., 20° C.) to cryogenic temperature, as with the aforementioned metal mirror composed of copper. Consequently, light usage efficiency in photochemical reaction can be raised by using a metal mirror that has been brought to cryogenic temperature in the photochemical reaction.

The metal composing the material of the aforementioned metal mirror may be selected at one's discretion so long as there are no particular problems, but it is preferable to use any one of copper, gold, silver, and aluminum.

Moreover, with respect to the metal composing the material of the metal mirror, the copper, gold, silver, and aluminum preferably have a purity of 99.9999% or more.

An above description is given for the case where a metal mirror composed of high-purity copper is cooled using liquid helium (temperature 4.2 K) to attain high reflectance. However, in the case where a reflectance R of about 0.999 is acceptable, the temperature of the metal mirror may be cooled to approximately 40 K.

Furthermore, in the case where the temperature of the metal mirror is cooled to about 100 K, it is possible to have a reflectance R that is a value close to 0.99, and to assure a reflection frequency of about 100. Consequently, light usage efficiency in photochemical reaction can be raised by using a metal mirror cooled to about 100 K in the photochemical reaction.

Furthermore, although the metal mirror is brought to cryogenic temperature, the temperature of the photochemical reaction cell in which the photochemical reaction is conducted must be set to a temperature that is suited to photochemical reaction.

This is because photochemical reaction is conducted in a gaseous state, and there is the problem that most gas solidifies at the temperature of liquid helium. Moreover, the material of the photochemical reaction cell must transmit laser light without loss.

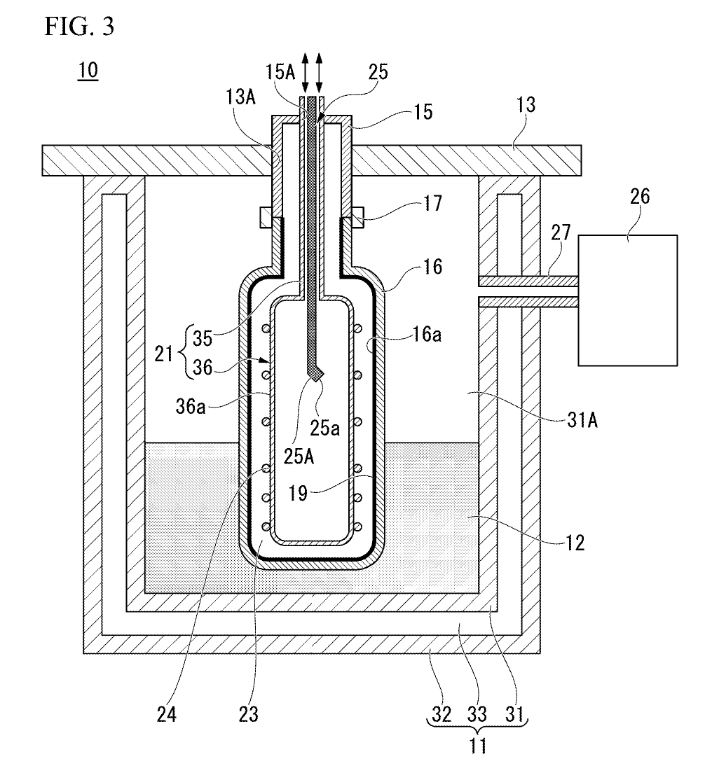

As a means for solving the foregoing problem, with respect to the material of the photochemical reaction cell (light-transmissive reaction cell 21 shown in the below-described FIG. 3 to FIG. 7), one may use high-purity synthetic quartz glass or acrylic resin or the like with a purity of 99% or more and a light-transmission loss of 0.1 dB/m or less that is used with optical fiber.

When conducting the photochemical reaction, it is advisable to provide a first vacuum insulation space between the metal mirror and the cell made with high-purity quartz glass (the light-transmissive reaction cell 21 shown in the below-described FIG. 3 to FIG. 7), while a process gas required for conduct of the photochemical reaction is supplied to or arbitrarily circulated into the light-transmissive reaction cell composed of the aforementioned quartz glass. The first vacuum insulation space may be filled with a diluted gas or the like of poor thermal conductivity.

In particular, as the optical loss of quartz glass used in optical fiber is extremely small at several dB per 1 km, and is much smaller than the optical loss from the multiple reflections of the reflecting mirrors, it is of non-problematic extent. Moreover, several percent of the laser light is reflected at the surface (both the inner and outer surface) of the light-transmissive reaction cell 21 (with the remainder passing through the light-transmissive reaction cell 21). However, as this reflected light is subsequently reflected by the metal mirror or the light-transmissive reaction cell 21, that is, the reflected light irradiates the process gas within the light-transmissive reaction cell 22 in the end, the laser light is utilized without waste.

Preferred embodiments of the present invention are described in detail below, but the present invention is not limited by these embodiments. Additions, omissions, substitutions, and other modifications are possible within a scope that does not deviate from the intent of the present invention.

### First Embodiment

FIG. 3 is a cross-sectional view which shows a schematic configuration of the photochemical reaction device of a first embodiment of the present invention.

A photochemical reaction device 10 of FIG. 3 has a cryostat 11, a cover 13, an annular component 15, a metal cell 16, a flange 17, a metal mirror 19, a light-transmissive reaction cell 21, a first vacuum insulation space 23, a line heater 24, a laser light waveguide 25, a reliquefaction device 26, and a conduit 27.

The cryostat 11 has a first cell 31, a second cell 32, and a second vacuum insulation space 33. The first cell 31 is a container which accommodates a cryogenic liquid 12.

The second cell 32 is set up so as to encompass the outer wall of the first cell 31 in a state of separation relative to the first cell 31. The second cell 32 accommodates the first cell 31. The second cell 32 is integrally configured with the first cell 31. The form of the first cell 31 and the second cell 32 may be selected at one's discretion, and a cylinder or square column or the like may be cited for purposes of exemplification.

The second vacuum insulation space 33 is a leaktight space provided between the first cell 31 and the second cell 32. The second vacuum insulation space 33 is established as a vacuum. By providing the second vacuum insulation space 33 established as a vacuum between the first cell 31 and the second cell 32 in this manner, it is possible to inhibit a rise in temperature of the cryogenic liquid 12 accommodated within the first cell 31.

The cryostat 11 configured in the foregoing manner cools the temperature of the metal mirror 19 to cryogenic temperature (100 K or less) by the cryogenic liquid 12, and maintains it at that temperature.

In the present invention, the phrase “maintain the temperature of the metal mirror at cryogenic temperature” signifies “maintain the cooled state of the metal mirror by the cryogenic liquid directly, or indirectly via a cell with which the metal mirror is provided.”

Consequently, it is acceptable to cool the metal mirror to cryogenic temperature in the ordinary sense of the term. However, it is also acceptable not to cool it to ordinary cryogenic temperature provided that the effect is obtainable. In this way, a temperature can be optionally selected for cooling. Moreover, so long as the effect is obtainable, the temperature of the metal mirror may be entirely uniform, or it may vary in parts. To cite an example of a preferable cooling temperature of the metal mirror, 100 K or less is generally preferable as stated above, 40 K or less is more preferable, and a temperature of liquid helium (4.2 K) is still more preferable.

The amount and type of the cryogenic liquid 12 can be selected at one's discretion, and the method and timing of the supply of the cryogenic liquid 12 to the cell 31 can also be selected at one's discretion within a problem-free scope.

As stated above, the temperature of the cooled metal mirror 19 can be selected according to purpose, and can, for example, be suitably selected within a range of 100 K or less. As the cryogenic liquid 12, for example, liquid helium (temperature 4.2 K) can be preferably used.

The cover 13 is provided at the upper end of the cryostat 11. By this means, a space 3A within the first cell 31 (a space accommodating the cryogenic liquid 12 and the metal cell 16) is leaktightly sealed. The cover 13 has a bore part 13A that serves to allow passage of the annular component 15.

The annular component 15 is fixed to the bore part 13A so as to pass through the cover 13. The upper end of the annular component 15 has a bore part 15A that serves to allow passage of the below-described tubular part 35 configuring the light-transmissive reaction cell 21. The lower end of the annular component 15 is open-ended. As the material of the annular component 15, for example, stainless steel may be used.

The metal cell 16 is accommodated within the first cell 31 (the space 31A) so that a portion thereof is immersed in the cryogenic liquid 12. The upper end of the metal cell 16 is fixed by the flange 17 to the lower end of the annular component 15. With respect to the method of fixation by the flange 17, a welding flange, a screw-in flange, or the like may be used. The flange 17 is provided at the junction of the annular component 15 and the metal cell 16.

The metal cell 16 accommodates the light-transmissive reaction cell 21 in a state where an interstice is interposed between the metal cell 16 and the light-transmissive reaction cell 21.

The metal cell 16 is composed of metal which is the same type as the metal that configures the metal mirror 19, and has lower purity than the metal that configures the metal mirror 19. The metal composing the material of the metal cell 16 can be selected at one's discretion, and, for example, any one metal from among gold, silver, copper, and aluminum may be used. In the case where gold, silver, copper, aluminum, or the like is used as the metal composing the material of the metal cell 16, the purity of the aforementioned metal can be set within a range of 99.9999% or more.

The metal mirror 19 is provided so as to cover an inner surface 16a of the metal cell 16. The metal mirror 19 is set up so as to encompass the light-transmissive reaction cell 21 on the outside of the light-transmissive reaction cell 21, and with interposition of a space therebetween. By reflecting laser light that is radiated from the laser light waveguide 25, the metal mirror 19 irradiates the process gas that is supplied to or circulated through the interior of the light-transmissive reaction cell 21 with reflected laser light.

The metal that composes the material of the metal mirror 19 may be selected at one's discretion, but high-purity gold, silver, copper, aluminum and the like are preferable.

In the case where gold, silver, copper, aluminum, or the like is used as the metal configuring the metal mirror 19, the purity of the metal configuring the metal mirror 19 can be set, for example, to 99.9999 or more.

For example, in the case where the metal mirror 19 composed of copper with a purity of 99.9999 or more is cooled by liquid helium (temperature 4.2 K), the reflectance R of the surface of the metal mirror 19 can be set to 0.9999 or more.

As the aforementioned reflectance R has the excellent feature that it is not dependent on the angle of incidence of laser light, the form of the inner surface of the metal cell 16 can be freely selected. From the standpoint of enlarging the optical path, it is advantageous that the form of the inner surface of the metal cell 16 be spherical, but it is also acceptable to have other forms such as a cylindrical form or a polygonal form (rectangular parallelepiped shape or the like).

Furthermore, there is no need to be concerned with the spread angle or the optical axis of the laser light that is radiated from the laser light waveguide 25. As most radiated laser light is attenuated according to the number of times the light reflects, such light can be utilized in photochemical reaction by undergoing maximal multiple reflection.

As the metal mirror 19, metal film (specifically, gold film, silver film, copper film, aluminum film, and the like) may be used which is formed, for example, by a method such as CVD (chemical vapor deposition), plating, coating, and vapor deposition.

In the case where metal film is coated onto a non-metallic surface as the metal mirror 19, the thickness of the aforementioned metal film may be optionally selected, and can be set, for example, to 0.02-10 μm. In the case where metal film is coated onto a metallic surface as the metal mirror 19, the thickness of the aforementioned metal film may be optionally selected, and can be set, for example, to 20 nm to 1 mm (or 1 mm or more).

The light-transmissive reaction cell 21 has a tubular part 35, and a reaction chamber 36. The tubular part 35 is fixed to the bore part 15A, and extends through the interior of the metal cell 16. The inner diameter of the tubular part 35 is configured to be narrower than the inner diameter of the reaction chamber 36. One end of the tubular part 35 is connected to a process gas supply device (not illustrated in the drawings) that supplies process gas, a process gas recovery device (not illustrated in the drawings), and/or a communicating piece (not illustrated in the drawings) that communicates with these and that may have an on-off valve or the like, while the other end is connected to the reaction chamber 36.

The reaction chamber 36 is accommodated in the metal cell 16 with an interstice interposed between the reaction chamber 36 and the metal mirror 19. The reaction chamber 36 is integrally configured with the tubular part 35. In the reaction chamber 36, process gas undergoes photochemical reaction by laser light when the process gas is supplied via the tubular part 35. The material of the light-transmissive reaction cell 21 may be selected at one's discretion, but it is preferable to use high-purity quartz glass or acrylic resin with a purity of 99% or more and a light transmission loss of 0.1 dB/m or less. The first vacuum insulation space 23 is provided between the metal mirror 19 and the light-transmissive reaction cell 21. The first vacuum insulation space 23 is a space that has been established as a vacuum.

By providing the first vacuum insulation space 23 between the metal minor 19 and the light-transmissive reaction cell 21 in this manner, it is possible to retard cooling of the light-transmissive reaction cell 21 by the cryogenic liquid 12. By this means, solidification of the process gas supplied to the interior of the light-transmissive reaction cell 21 can be inhibited.

The line heater 24 is wound around an outer wall 36a of the reaction chamber 36. As it becomes possible to heat the reaction chamber 36 by winding the line heater 24 around the outer wall 36a of the reaction chamber 36 in this manner, the temperature of the interior of the reaction chamber 36 can be adjusted to a temperature suited to photochemical reaction.

The laser light waveguide 25 is set up within the tubular part 35 and in the upper portion of the reaction chamber 36. The laser light waveguide 25 has a laser radiation face 25a that radiates laser light at its distal end 25A.

Here, the laser light waveguide 25 is optical system equipment configured from lenses, mirrors, and the like, and is a member that serves to introduce laser light into the light-transmissive reaction cell 21. This laser light waveguide 25 may be selected at one's discretion, but optical fiber is ideal.

As an example, FIG. 1 illustrates the case where radiation occurs in a state where laser light spreads out from the laser radiation face 25a. However, it is also acceptable to render the laser light as collimated light by setting up a lens (not illustrated in the drawing) at the distal end 25A of the laser light waveguide 25.

The reliquefaction device 26 is provided outside of the cryostat 11. The reliquefaction device 26 is connected to the conduit 27 that passes through a side wall of the cryostat 11, and that connects to the space 31A inside the first cell 31. The reliquefaction device 26 is a device which cools and reliquefies the evaporated cryogenic liquid 12 with a pulse tube refrigerator or a Gifford-McMahon refrigerator, and returns it to the cryogenic liquid 12. It is also acceptable to provide an on-off unit (not illustrated in the drawings) in the reliquefaction device 26 or conduit 27.

As it is possible to continuously cool the cryogenic liquid 12 by thus providing the reliquefaction device 26 that reliquefies the cryogenic liquid 12 stored inside the first cell 31 when it evaporates, it is possible to stably maintain the temperature of the metal mirror 19 at cryogenic temperature.

According to the photochemical reaction device of the first embodiment, it is possible to raise the laser light reflectance of the metal mirror 19 by virtue of the light-transmissive reaction cell 21 which causes a process gas supplied to its interior to undergo photochemical reaction by laser light, the metal mirror 19 which is set up outside the light-transmissive reaction cell 21 so as to encompass the light-transmissive reaction cell 21, and which reflects laser light, the metal cell 16, and the cryostat 11 which has a configuration enabling accommodation of the cryogenic liquid 12, the metal mirror 19, and the light-transmissive reaction cell 21, and which maintains the temperature of the metal mirror 19 at cryogenic temperature (a temperature of 100 K or less) by the cryogenic liquid 12. By this means, it is possible to raise the usage efficiency of laser light in photochemical reaction.

As it is possible to achieve a high reflectance R of 0.9999 or more by cooling the metal mirror 19 to a temperature close to the temperature of liquid helium using liquid helium (temperature 4.2 K) as the cryogenic liquid 12, laser light usage efficiency in photochemical reaction can be raised to the utmost.

Referencing FIG. 1, a description is now given of an example of isotope enrichment method using the photochemical reaction device 10 of the foregoing configuration. In the following method, a mixture of CF₄ and ozone (O₃) is used as the process gas, but the present invention can, of course, also be applied in cases where other process gases are used.

To begin with, a mixture of CF₄ and ozone (O₃) is supplied to the reaction chamber 36 of the light-transmissive reaction cell 21 as the process gas. Subsequently, by irradiating the mixture supplied to the interior of the reaction chamber 36 with laser light by means of the laser light waveguide 25 to induce photochemical reaction, isotopologues of ozone including ¹⁷O or ¹⁸O which are oxygen isotopes contained in the ozone undergo selective photodecomposition into oxygen. That is, ozone containing the target oxygen isotopes in molecules are selectively decompose into oxygen.

At this time, as laser light reflectance is raised by conducting reflection of laser light using the metal mirror 19 cooled to cryogenic temperature (100 K or less) as previously described, the usage efficiency of laser light in the photochemical reaction can be raised.

In the case where laser light is introduced using optical fiber during conduct of the photochemical reaction, the wavelength range of laser light can be optionally selected, but use of 500-1500 nm where the optical loss of the optical fiber is small is optimal.

In the case where optical fiber is not used, laser light can be introduced, for example, using a reflecting mirrors or lenses. With respect to the wavelength range of laser light in this case, it is preferable to use of 800 nm or more where the reflectance of the metal mirror 19 is high.

With respect to the wavelength range of laser light when photochemical reaction is conducted using a mixture of ozone and CF₄ as the process gas, 700-1200 nm—which is referred to as the Wulf band—is preferable. By setting the wavelength range of laser light at 700-1200 nm in this manner, it is possible to obtain the effect of enabling selective decomposition of ozone containing the oxygen isotopes ¹⁷O or ¹⁸O.

Subsequently, the oxygen in the mixture can be separated from the undecomposed ozone and CF₄. In this manner, it is possible to enrich the ¹⁷O or ¹⁸O—which are oxygen isotopes—in the separated oxygen.

According to the isotope enrichment method using the photochemical reaction device of the first embodiment, by using the photochemical reaction device 10 in which laser light is reflected by the metal mirror 19 that is cooled to cryogenic temperature (100 K or less), by supplying a mixture in which ozone (O₃) and CF₄ are mixed to the reaction chamber 36 of the light-transmissive reaction cell 21 as the process gas, and by subsequently irradiating the aforementioned mixture with laser light to subject ozone containing the oxygen isotopes ¹⁷O or ¹⁸O to selective photodecomposition, it is not only possible to raise the usage efficiency of laser light in photochemical reaction, but also to enrich the oxygen isotopes ¹⁷O or ¹⁸O.

### Second Embodiment

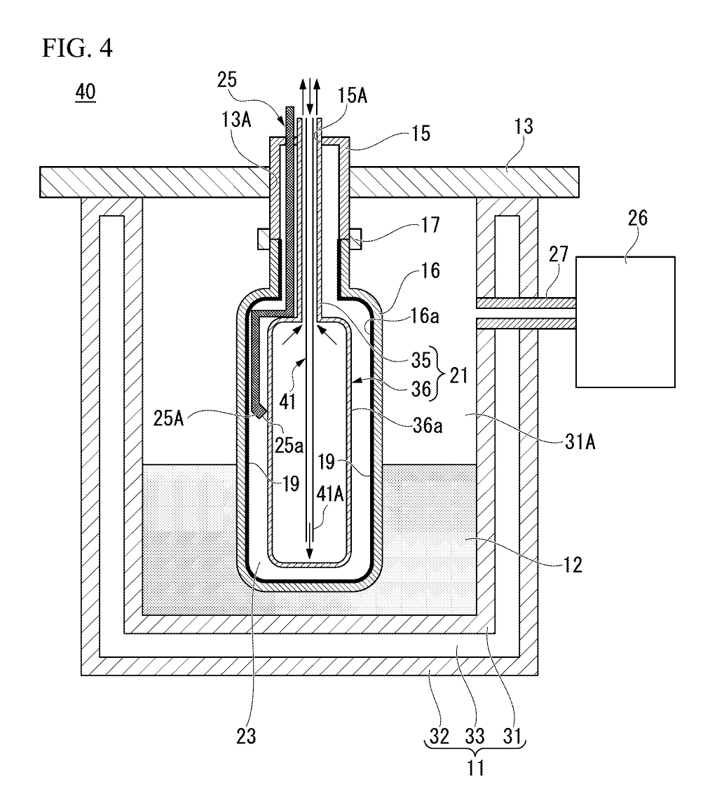

FIG. 4 is a cross-sectional view which shows a schematic configuration of a photochemical reaction device according to a second embodiment of the present invention. In FIG. 4, components identical to those of the photochemical reaction device 10 of the first embodiment shown in FIG. 3 are assigned the same reference numbers.

A photochemical reaction device 40 of the second embodiment shown in FIG. 4 has the same configuration as the photochemical reaction device 10, except that a gas supply tube 41 is provided, and the laser light waveguide 25 is set up in the first vacuum insulation space 23 (between the metal mirror 19 and the light-transmissive reaction cell 21) in the configuration of the photochemical reaction device 10 of the first embodiment, and also that the line heater 24 provided in the photochemical reaction device 10 is eliminated as a component.

The gas supply tube 41 is set up within the light-transmissive reaction cell 21. The gas supply tube 41 is connected to the process gas supply source (not illustrated in the drawings) that supplies the process gas. A distal end 41A of the gas supply tube 41 (the part that supplies process gas to the interior of the reaction chamber 36) is set up at a site near the bottom of the reaction chamber 36.

In the photochemical reaction device 40 of the second embodiment, gas is discharged from an interstice between the tubular part 35 and the gas supply tube 41. By this means, it is possible to continuously circulate process gas, and conduct continuous processing of a photochemical reaction in the second embodiment. Instead of continuous processing, it is also acceptable to conduct processing in which the contents are replaced each time. Moreover, the temperature of the reaction chamber 36 can be controlled by setting the temperature at the time of introduction of the process gas.

According to the photochemical reaction device of the second embodiment, as contact between the process gas and the laser light waveguide 25 is eliminated by setting up the laser light waveguide 25 in the first vacuum insulation space 23 between the metal mirror 19 and the light-transmissive reaction cell 21, it is possible to prevent contamination of process gas deriving from the laser light waveguide 25.

The photochemical reaction device 40 of the second embodiment can obtain the same effects as the photochemical reaction device 10 of the first embodiment. Specifically, as it is possible to raise the laser light reflectance of the metal mirror 19, the usage efficiency of laser light in photochemical reaction can be raised.

The isotope enrichment method using the photochemical reaction device 40 of the second embodiment can be conducted by the same techniques as the isotope enrichment method using the photochemical reaction device 10 described in the first embodiment, and can obtain the same effects as the isotope enrichment method using the photochemical reaction device 10.

Otherwise, it is also acceptable to provide the line heater 24 shown in FIG. 1 in the photochemical reaction device 40 of the second embodiment.

### Third Embodiment

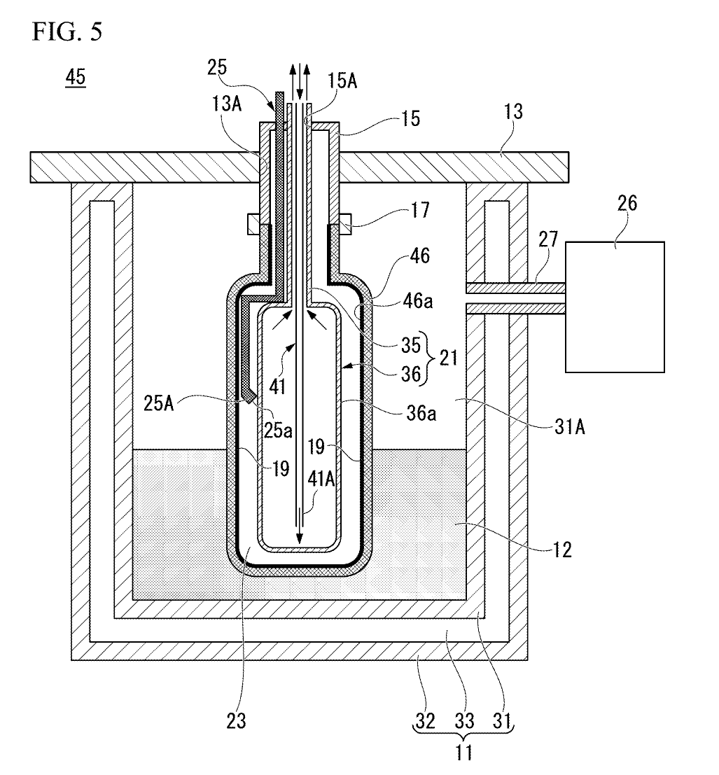

FIG. 5 is a cross-sectional view which shows a schematic configuration of a photochemical reaction device of a third embodiment of the present invention. In FIG. 5, components identical to those of the photochemical reaction device 40 of the second embodiment shown in FIG. 4 are assigned the same reference numbers.

A photochemical reaction device 45 of the third embodiment shown in FIG. 5 has the same configuration as the photochemical reaction device 40, except that a quart glass cell 46 is provided, instead of the metal cell 16 provided in the photochemical reaction device 40 of the second embodiment.

The quart glass cell 46 is accommodated in the cryostat 11, and accommodates the light-transmissive reaction cell 21. The quart glass cell 46 is composed of high-purity quartz glass which transmits laser light, which has a purity of 99% of more, and which has a light transmission loss of 0.1 dB/m or less. The quartz glass composing the quart glass cell 46 can reduce heat capacity compared to the metal (e.g., gold, silver, copper, aluminum, and the like) composing the metal cell 16.

The metal mirror 19 is provided so as to cover an inner surface 46a of the quart glass cell 46. In the case of the present embodiment, it is possible to use a metal film (e.g., a gold film, silver film, copper film, aluminum film, or the like with a purity of 99.9999% or more) that is formed by coating or vapor deposition as the metal mirror 19. The thickness of the aforementioned metal film can be set, for example, to 0.02-10 μm.

According to the photochemical reaction device of the third embodiment, by providing the quart glass cell 46 that accommodates the light-transmissive reaction cell 21 instead of the metal cell 16, the metal mirror 19 can be efficiently cooled by the cryogenic liquid 12, because the heat capacity of quartz glass is smaller than that of metal.

In addition, as it is possible to reduce tensile stress due to the difference in the thermal expansion coefficient of the quart glass cell 46 and the metal mirror 19 by providing the metal mirror 19 on the inner surface 46a of the quart glass cell 46, reduction of the reflectance R of the metal mirror 19 can be inhibited.

Otherwise, the isotope enrichment method using the photochemical reaction device 45 of the third embodiment can be conducted by the same techniques as the isotope enrichment method using the photochemical reaction device 10 described in the first embodiment.

It is also acceptable to provide the line heater 24 shown in FIG. 1 in the photochemical reaction device 45 of the third embodiment.

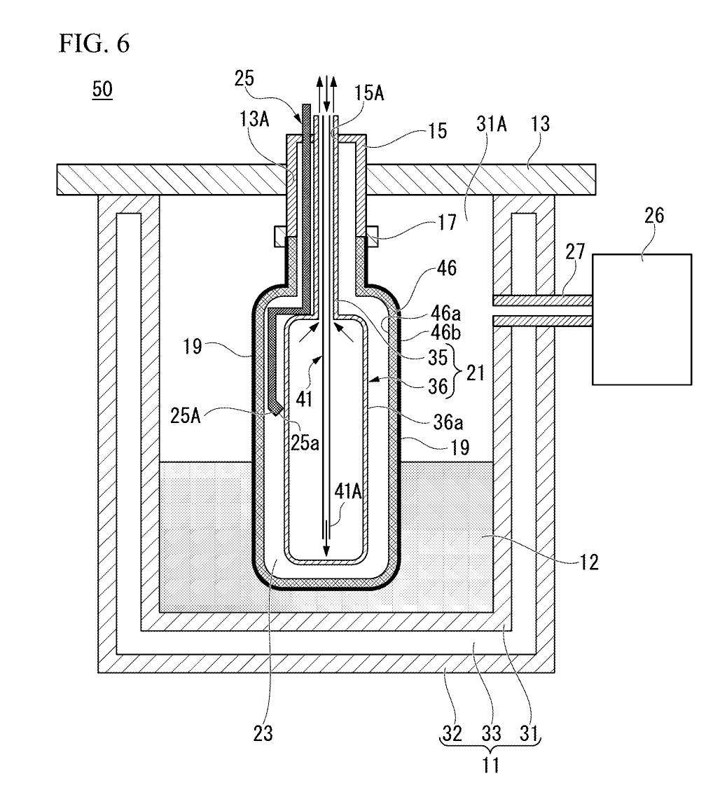

FIG. 6 is a cross-sectional view which shows a schematic configuration of a photochemical reaction device that is a variation of the third embodiment of the present invention. In FIG. 6, components identical to those of the photochemical reaction device 45 of the third embodiment shown in FIG. 5 are assigned the same reference numbers.

A photochemical reaction device 50 which is shown in FIG. 6 and which is a variation of the third embodiment has the same configuration as the photochemical reaction device 45 of the third embodiment, except that the metal mirror 19 which is provided in the photochemical reaction device 45 in the third embodiment is provided so as to cover an outer surface 46b of the quart glass cell 46 (external cell: first quart glass cell), rather than the inner surface.

The photochemical reaction device 50 which is configured in this manner and which is a variation of the third embodiment can efficiently cool the metal mirror 19 with the cryogenic liquid 12 by virtue of the quart glass cell 46 that accommodates the light-transmissive reaction cell 21.

Otherwise, the isotope enrichment method using the photochemical reaction device 50 of the variation of the third embodiment can be conducted by the same techniques as the isotope enrichment method using the photochemical reaction device 10 described in the first embodiment.

It is also acceptable to provide the line heater 24 shown in FIG. 1 in the photochemical reaction device 50 of the variation of the third embodiment.

### Fourth Embodiment

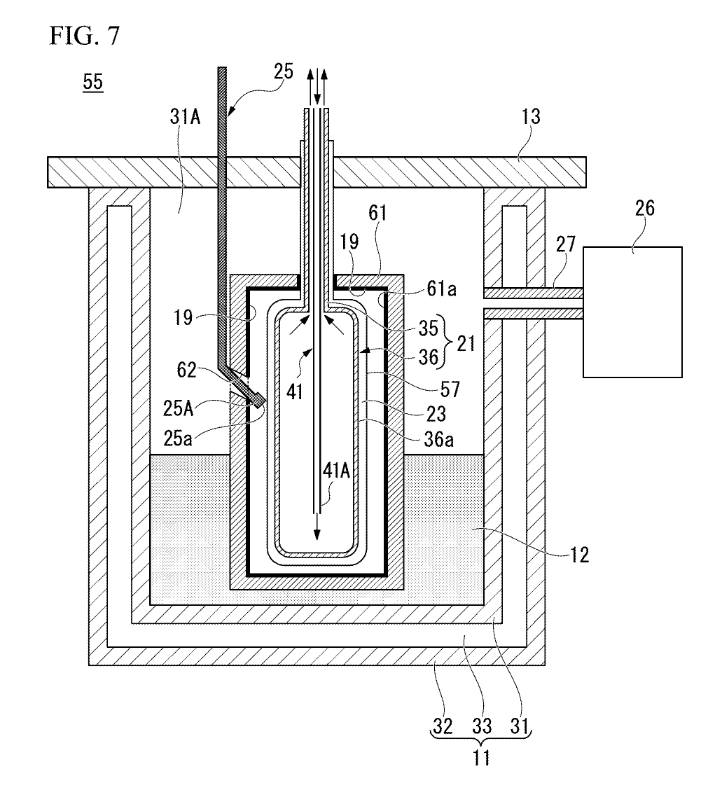

FIG. 7 is a cross-sectional view which shows a schematic configuration of a photochemical reaction device of a fourth embodiment of the present invention. In FIG. 7, components identical to those of the photochemical reaction device 40 of the second embodiment shown in FIG. 4 are assigned the same reference numbers.

A photochemical reaction device 55 of the fourth embodiment shown in FIG. 7 has the same configuration as the photochemical reaction device 40, except that—in the configuration of the photochemical reaction device 40 of the second embodiment—a quart glass cell 57 is provided, and a metal cell 61 is provided which is set up within a space 31A with passage of a portion of the laser light waveguide 25 through a hole in the side face of the metal cell 61, which passes to the outside from a through hole provided in the cover 13, which substitutes for the metal cell 16 provided in the photochemical reaction device 40, and which differs from the aforementioned cell, and also that the annular component 15 and the flange 17 provided in the photochemical reaction device 40 are eliminated as components.

The quart glass cell 57 is provided between the metal mirror 19 and the light-transmissive reaction cell 21. The quart glass cell 57 is set up so as to encompass the light-transmissive reaction cell 21. The quart glass cell 57 transmits laser light. The quart glass cell 57 is configured from high-purity quartz glass with a purity of 99% or more, and a light transmission loss of 0.1 dB/m or less.

In the photochemical reaction device 55 of the fourth embodiment, a first vacuum insulation space 23 is provided between the light-transmissive reaction cell 21 and the quart glass cell 57.

Provided that it is positioned between the light-transmissive reaction cell 21 and the quart glass cell 57, the scope, form, and position of the first vacuum insulation space 23 may be selected at one's discretion. The first vacuum insulation space 23 may be formed by combining the light-transmissive reaction cell 21 and the quart glass cell 57 at desired positions.

The space between the metal mirror 19 and the quart glass cell 57 is not established as a vacuum.

The metal cell 61 is fixed to the first cell 31 by an optional method (the fixation method is not illustrated in the drawings) so as to encompass the quart glass cell 57. A through hole 62 is provided in the metal cell 61 in order to set up the distal end 25A of the laser light waveguide 25 in the space provided between the metal mirror 19 and the quart glass cell 57 from the exterior of the metal cell 61. The laser light waveguide 25 is set up outside of the quart glass cell 57. As the material of the metal cell 61, one may use the same metal as that of the metal cell 16 described in the second embodiment.

According to the photochemical reaction device of the fourth embodiment, the need to establish a vacuum within the metal cell 61 is eliminated by providing the quart glass cell 57 that encompasses the light-transmissive reaction cell 21, and by setting up the first vacuum insulation space 23 between the light-transmissive reaction cell 21 and the quart glass cell 57. In other words, there is no need to leaktightly seal the interior of the metal cell 61.

By this means, the metal cell 61 can be configured by assembling a multiplicity of divided parts.

Although not illustrated in FIG. 7, with the present invention, it is possible to fully secure a space in which an insulation jacket is set up for purposes of using the optical fiber of the laser light waveguide 25 at a constant temperature.

Moreover, it is also possible to irradiate the light-transmissive reaction cell 21 directly with laser light from a laser radiation device (not illustrated in the drawings) without using optical fiber. In this case, a mirror or the like that reflects laser light, and a window (a window capable of transmitting laser light) for projecting laser light can be suitably provided in the cryostat 11 and the metal cell 61.

It is also acceptable to provide the line heater 24 shown in FIG. 1 in the photochemical reaction device 55 of the fourth embodiment.

While preferred embodiments of the invention have been described and illustrated above, it should be understood that the present invention is not limited merely to the embodiments. Various change and modifications can be made without departing from the scope of the present invention. Accordingly, among the first to the fourth embodiments, preferred examples may be mutually exchanged or added within a problem-free scope.

For example, with respect to the photochemical reaction device 10, 40, 45, 50, and 55 described in the first to the fourth embodiments, the description concerned the case where a single optical fiber is used as the laser light waveguide 25, but multiple optical fiber strands may also be provided.

### EXAMPLE

Table 1 shows a process calculation example when the oxygen isotope ¹⁷O in ozone molecules is enriched using the photochemical reaction device 55 of the fourth embodiment (a device that generates continuous photochemical reaction), and using a mixture in which ozone (O₃) and CF₄ are mixed as the process gas.

The process calculation example recorded in Table 1 pertains to the oxygen isotope enrichment process of Patent Document 2 (Japanese Unexamined Patent Application, First Publication No. 2006-272090) described above.

Table 1 shows first-stage, second-stage, and total results when two-stage enrichment is carried out by conducting photochemical reaction by irradiation of laser light two times using high-purity oxygen as the raw material (¹⁶O, ¹⁷O and ¹⁸O are in concentrations proportionate to their natural existence).

TABLE 1

| | First stage | Second stage | Total | |
|---|---|---|---|---|
| Process pressure | 13 | 13 | | kPa (absolute) |
| Average optical length per reflection | 1 | 1 | | m |
| Reflectance | 0.9999 | 0.9999 | | [—] |
| Total optical path length | 10000 | 10000 | | m |
| Process gas composition | | | | |
| Ozone | 10 | 10 | | mol % |
| CF₄ | 90 | 90 | | mol % |
| Oxygen isotope composition | | | | |
| ¹⁶O | 99.759 | 99.05 | 88.3 | atom % |
| ¹⁷O | 0.037 | 0.75 | 11.6 | atom % |
| ¹⁸O | 0.204 | 0.20 | 0.1 | atom % |
| Target ¹⁶O ¹⁶O ¹⁷O molecular density | 2.6E+14 | 5.2E+15 | | molecules/cm³ |
| Target ¹⁶O ¹⁶O ¹⁷O absorption wavelength | 998 | 998 | | nm |
| Optical absorption sectional area | 3.0E−23 | 3.0E−23 | | cm²/molecule |
| Optical absorption coefficient | 3.9E−09 | 1.6E−07 | | cm⁻¹ |
| Process gas flow rate | 3.1E−03 | 8.6E−05 | | mol/s |
| Laser output | 100 | 4.8 | 104.8 | W |
| Quantum yield of optical reaction | 1.2 | 1.2 | | [—] |
| ¹⁷O yield | 0.56 | 0.55 | 0.30 | [—] |
| Enriched ¹⁷O concentration | 0.75 | 11.6 | 11.6 | atom % |
| ¹⁷O enrichment rate | 20.3 | 17.5 | | [—] |
| Amount of product H₂¹⁷O produced | | | 3.0E−06 | mol/s |
| Amount of product H₂¹⁷O produced (annual amount) | | | 3.5 | kg/y |

The raw material oxygen is converted into ozone-oxygen gas by an ozonizer, and is introduced into a distillation column into which CF₄ has been introduced, after which ozone-CF₄ gas is derived from the bottom of the aforementioned distillation column. This ozone-CF₄ gas is used as the process gas of the present invention.

¹⁷O is enriched in the light-transmissive reaction cell 21, and the ¹⁷O in the oxygen constituting the final product is enriched to 10 atom % or more.

The target absorption wavelength of the ozone isotopologue ¹⁶O¹⁶O¹⁷O including ¹⁷O is approximately 1000 nm, which is within the wavelength range where the optical fiber in the laser light waveguide 25 can be used with low loss. This is important, because the employed optical fiber is easily obtainable, and photochemical reaction can be conducted with minimization of laser light loss.

The results shown in Table 1 are also obtained even when the oxygen isotope ¹⁷O in ozone molecules is enriched using the photochemical reaction devices 40, 45, and 50 described in the second and third embodiments (devices which continuously engender photochemical reaction), and using a mixture in which ozone (O₃) and CF₄ are mixed as the process gas.

### INDUSTRIAL APPLICABILITY

The present invention can be applied to a photochemical reaction device using laser light, and an isotope enrichment method using the photochemical reaction device. The present invention provides a photochemical reaction device which enables enhancement of the usage efficiency of laser light in photochemical reaction, and an isotope enrichment method.

### DESCRIPTION OF THE REFERENCE NUMERALS

10, 40, 45, 50, 55: photochemical reaction device

11: cryostat

12: cryogenic liquid

13: cover

13A, 15A, 62: through hole

15: annular component

16, 61: metal cell

16a, 46a, 61a: inner surface

17: flange

19: metal mirror

21: light-transmissive reaction cell

23: first vacuum insulation space

24: line heater

25: laser light waveguide

25a: laser radiation face

25A, 41A: distal end

26: reliquefaction device

27: conduit

31: first cell

31A: space

32: second cell

33: second vacuum insulation space

35: tubular part

36: reaction chamber

36a: outer wall

41: gas supply tube

46: quart glass cell (external cell: first quart glass cell)

46b: outer surface

57: quart glass cell (inner cell: second quart glass cell)

1. A photochemical reaction device, comprising:
a light-transmissive reaction cell in which a process gas is supplied and a photochemical reaction is carried out with a laser light;
a metal mirror which is set outside of the light-transmissive reaction cell so as to encompass said light-transmissive reaction cell, and which reflects the laser light;
and a cryostat which accommodates the light-transmissive reaction cell, the metal mirror, and a cryogenic liquid, and which maintains a temperature of the metal mirror at a cryogenic temperature by the cryogenic liquid.

2. The photochemical reaction device according to claim 1, wherein a temperature of the metal mirror is 100 K or less.

3. The photochemical reaction device according to claim 1, wherein a vacuum insulation space exists between the light-transmissive reaction cell and the metal minor.

4. The photochemical reaction device according to claim 1, wherein the metal mirror is made of any one metal of gold, silver, copper, and aluminum.

5. The photochemical reaction device according to claim 4, wherein a purity of the metal is 99.9999 or more.

6. The photochemical reaction device according to claim 1, wherein the metal mirror is a metal film.

7. The photochemical reaction device according to claim 1, wherein the light-transmissive reaction cell is made of quartz glass or acrylic resin.

8. The photochemical reaction device according to claim 1, comprising a laser light waveguide through which the process gas is irradiated with the laser light.

9. The photochemical reaction device according to claim 1, comprising a metal cell which is made of the same metal as the metal mirror, and that has a purity lower than that of the metal mirror, which is accommodated in the cryostat, and which accommodates the light-transmissive reaction cell;
wherein the metal mirror is set so as to cover an inner surface of the metal cell.

10. The photochemical reaction device according to claim 1, comprising a quart glass cell which is accommodated in the cryostat, which accommodates the light-transmissive reaction cell, and which transmits the laser light;
wherein the metal mirror is set so as to cover an inner surface of the quart glass cell or an outer surface of the quart glass cell.

11. The photochemical reaction device according to claim 10, wherein the quart glass cell is made of high-purity quartz glass with a purity of 99% or more, and a light transmission loss of 0.1 dB/m or less.

12. The photochemical reaction device according to claim 8, wherein the laser light waveguide is set up in the light-transmissive reaction cell.

13. The photochemical reaction device according to claim 8, which has a vacuum insulation space between the light-transmissive reaction cell and the metal mirror, and wherein the laser light waveguide is set up in the vacuum insulation space.

14. The photochemical reaction device according to claim 8, wherein the laser light waveguide is optical fibers.

15. The photochemical reaction device according to claim 1, wherein a line heater is wound on an outer wall of the light-transmissive reaction cell.

16. The photochemical reaction device according to claim 9, wherein a quart glass cell which transmits the laser light and encompasses the light-transmissive reaction cell is provided between the light-transmissive reaction cell and the metal mirror, and a vacuum insulation space is set up between the light-transmissive reaction cell and the quart glass cell.

17. The photochemical reaction device according to claim 16, wherein the laser light waveguide is set up outside of the quart glass cell.

18. The photochemical reaction device according to claim 16, wherein the quart glass cell is made of high-purity quartz glass with a purity of 99% or more, and a light transmission loss of 0.1 dB/m or less.

19. The photochemical reaction device according to claim 1, wherein the light-transmissive reaction cell is made of high-purity quartz glass with a purity of 99% or more, and a light transmission loss of 0.1 dB/m or less.

20. The photochemical reaction device according to claim 1, wherein the cryostat has a first cell that accommodates the cryogenic liquid, a second cell that accommodates the first cell, and a vacuum insulation space provided between the first cell and the second cell.

21. The photochemical reaction device according to claim 20, comprising a reliquefaction device that is connected to the first cell, and that reliquefies a boil-off gas from the cryogenic liquid.

22. The photochemical reaction device according to claim 1, wherein the cryogenic liquid is liquid helium.

23. An isotope enrichment method using the photochemical reaction device according to claim 1, comprising:
a step in which a mixture of O₃ and CF₄ as the process gas is supplied into the light-transmissive reaction cell;
and a succesive step in which the O₃ containing an oxygen isotope ¹⁷O or ¹⁸O is selective photodecomposed by photochemical reaction by irradiating the mixture with the laser light.

24. The isotope enrichment method using a photochemical reaction device according to claim 23, wherein the wavelength range of the laser light during the photodecomposition is 500 nm or more.

25. The isotope enrichment method using a photochemical reaction device according to claim 23, wherein the wavelength range of the laser light during the photodecomposition is 700-1500 nm.
